(19) United States
(12) Patent Application Publication
(10) Pub. No.: US 2021/0114574 A1
(43) Pub. Date: Apr. 22, 2021

(54) BRAKE DEVICE, ELECTRIC BRAKE DEVICE, AND MOTOR CONTROL DEVICE

(71) Applicant: HITACHI AUTOMOTIVE SYSTEMS, LTD., Hitachinaka-shi, Ibaraki (JP)

(72) Inventor: Haruhiko FUJITA, Machida-shi, Tokyo (JP)

(21) Appl. No.: 16/981,782

(22) PCT Filed: Feb. 20, 2019
(86) PCT No.: PCT/JP2019/006207

§ 371 Date: Sep. 17, 2020

(30) Foreign Application Priority Data
Mar. 27, 2018 (JP) 2018-060359

(51) Int. Cl. B60T 13/74; F16D 65/18; F16D 55/226; B60T 8/17

(52) U.S. Cl. CPC B60T 13/74; F16D 65/18; F16D 55/226; F16D 2121/24; B60T 2270/414; B60T 13/746; B60T 8/17

(57) ABSTRACT

The invention is provided with an electric motor driven by receiving power supply from a first electricity storage device, and a second electricity storage device capable of storing higher voltage than the first electricity storage device. Electric power is supplied from the second electricity storage device to the electric motor when the electric motor is required to be driven at higher rotating speed than predetermined rotating speed.

### TECHNICAL FIELD

The invention relates to a brake device and an electric brake device which generate a braking force using an electric motor, and a motor control device.

### BACKGROUND ART

For example, Patent Literature 1 discloses an electric brake device comprising a caliper that includes a caliper body internally equipped with a piston, a motor, and a ball ramp mechanism. The ball ramp mechanism converts the rotation of the motor into linear motion and transmits the linear motion to the piston. The electric brake device actuates the ball ramp mechanism in response to the rotation of the motor to propel the piston and thus presses brake pads against a disc rotor to generate a braking force.

### CITATION LIST

### Patent Literature

PTL 1: Japanese Unexamined Patent Application Publication (Kokai) No. 2006-105170

### SUMMARY OF INVENTION

### Technical Problem

In order to improve the responsiveness of a brake device, it is necessary to increase source current for driving a motor, which causes a problem that parts cost for the device is increased.

### Solution to Problem

An object of the invention is to provide a brake device and an electric brake device which are improved in responsiveness or realizes high responsiveness while source current is prevented or suppressed from being increased, and further provide a motor control device.

One embodiment of the invention includes an electric motor that is driven by receiving power supply from a first electricity storage device, and a second electricity storage device capable of storing higher voltage than the first electricity storage device. When the electric motor is required to be driven at higher rotating speed than predetermined rotating speed, electric power is supplied from the second electricity storage device to the electric motor.

The one embodiment of the invention makes it possible to improve the responsiveness of the brake device while preventing or suppressing the increase of source current.

### BRIEF DESCRIPTION OF DRAWINGS

FIG. 1 is a block diagram showing a major part of an electric brake device according to a first embodiment of the invention.

FIG. 2 is a block diagram showing a major part of a motor control device in the electric brake device shown in FIG. 1.

FIG. 3 shows an example of timing of switching between a first electricity storage device and a second electricity storage device in the electric brake device of FIG. 1: FIG. 3 (a) is a graph showing temporal changes in source voltage of the first and second electricity storage devices; and FIG. 3 (b) is a graph showing a temporal change in source voltage that is outputted from a main control portion to a motor driving portion of a caliper-side control portion.

FIG. 4 is a block diagram showing a major part of a brake device according to a second embodiment of the invention.

### DESCRIPTION OF EMBODIMENTS

Embodiments of the invention will be discussed with reference to the attached drawings.

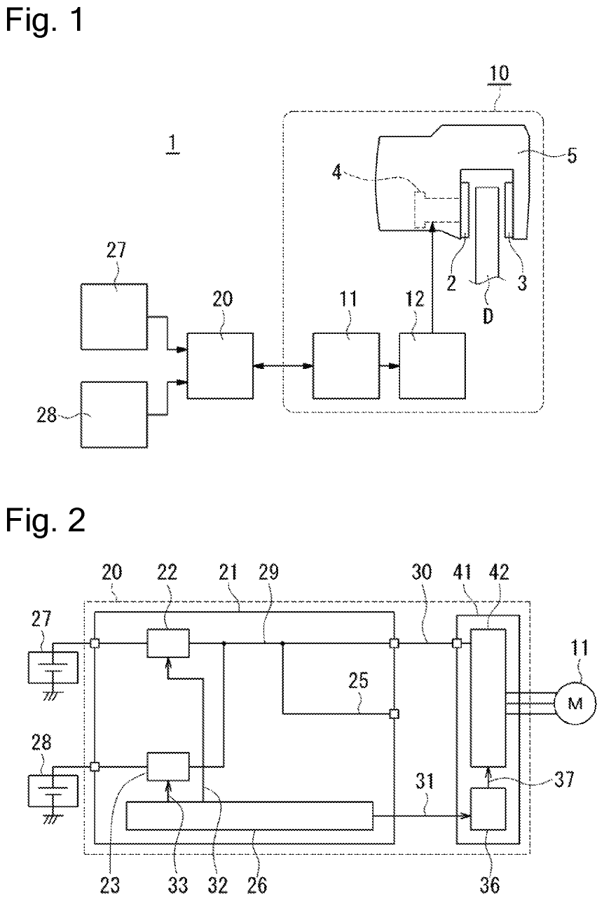

FIG. 1 is a block diagram showing a major part of an electric brake device 1 according to a first embodiment of the invention. FIG. 2 is a block diagram showing a major part of a motor control device 20 in the electric brake device shown in FIG. 1. The electric brake device 1 is a braking device that applies a braking force to each wheel by squeezing a disc D rotating with each wheel, not shown, of a vehicle. As shown in FIG. 1, the electric brake device 1 includes a brake mechanism 10 including brake pads 2 and 3 pressed against the disc D and a piston 4 that moves the brake pads 2 and 3. The brake mechanism 10 is provided with respect to each wheel to be braked by the electric brake device 1. The brake mechanism 10 further includes an electric motor 11 and a rotation-linear motion conversion mechanism 12 that converts rotation of the electric motor 11 into linear motion and transmits the linear motion to the piston 4.

As mentioned, the electric brake device 1 includes the brake mechanism 10 that is provided with respect to each wheel to be braked by the electric brake device 1. The brake mechanism 10 therefore typically comprises a plurality of brake mechanisms 10 (for four wheels if the vehicle is a four-wheel vehicle, for example). For concise illustration and explanation, the electric brake device 1 is discussed here in relation chiefly to one of the brake mechanisms 10 and constituent elements thereof. The matters discussed in relation to one brake mechanism 10 are applicable to any other brake mechanisms, unless otherwise clearly noted.

The electric brake device 1 further includes the motor control device 20 that controls operation of the electric motor 11, and first and second electricity storage devices 27 and 28 that supply electric power to the electric motor 11 through the motor control device 20. The second electricity storage device 28 is capable of storing higher voltage than the first electricity storage device 27. As described below in detail, the motor control device 20 switches between the first electricity storage device 27 and the second electricity storage device 28 and supplies electric power to the electric motor 11.

According to the first embodiment, the first electricity storage device 27 comprises an electricity storage device (lead-acid automobile battery, for example) that functions as a vehicle power source, and the second electricity storage device 28 comprises an electric double-layer capacitor (EDLC). The voltage of the first electricity storage device 27 ranges, for example, from 12 V to 14 V. The second electricity storage device 28 is capable of storing electricity, for example, so that the voltage thereof ranges from 24 V to 30 V.

In FIG. 1, the electric motor 11 and the rotation-linear motion conversion mechanism 12 are both located outside a caliper 5 as separate blocks from the caliper 5. The drawing shows the electric motor 11 and the rotation-linear motion conversion mechanism 12 as functional blocks simply in a schematic way and is not intended to limit the spatial arrangement of the constituents 11 and 12. In the brake device 1, the electric motor 11 and the rotation-linear motion conversion mechanism 12 are disposed in the caliper 5 together with the piston 4. The brake mechanism 10 according to the first embodiment may include a freely-selected proper constituent element (for example, a deceleration mechanism that decelerates the rotation of the electric motor 11) that enables the brake mechanism 10 to function as a braking device that imparts a braking force to each wheel by squeezing the disc D rotating with the wheel.

As shown in FIG. 2, the motor control device 20 included in the electric brake device 1 includes a main control portion 21 and a caliper-side control portion 41. The main control portion 21 includes first and second input-side switching circuits 22 and 23, first and second output-side switching circuits (not shown in FIG. 2), and a controller 26. The caliper-side control portion 41 includes a motor driving portion 42 and a controller 36.

The controller 26 and/or the controller 36 may be connected to a vehicle data bus, not shown, to receive and send a variety of information including information necessary for controlling the motor driving portion 42 described later from and to each other and/or another electronic control device (ECU) through communication using the vehicle data bus.

In the main control portion 21, the first and second input-side switching circuits 22 and 23 are circuit devices having at least two states including a conductive state (hereinafter, referred to as ON state or simply ON) and a non-conductive state (hereinafter, referred to as OFF state or simply OFF). The two states are switched by control signals 32 and 33 transmitted from the controller 26.

The first electricity storage device 27 is connected to a power supply line 29 in the main control portion 21 through the first input-side switching circuit 22. The second electricity storage device 28 is connected to the power supply line 29 in the main control portion 21 through the second input-side switching circuit 23. Accordingly, when the first input-side switching circuit 22 is turned ON, and the second input-side switching circuit is turned OFF in response to the control signals 32 and 33 transmitted from the controller 26, voltage from the first electricity storage device 27 is inputted into the power supply line 29. When the first input-side switching circuit 22 is turned OFF, and the second input-side switching circuit 23 is turned ON in response to the control signals 32 and 33 transmitted from the controller, voltage from the second electricity storage device 28 is inputted into the power supply line 29.

In the motor control device 20, a power supply line 30 that outputs source voltage from the main control portion 21 to the caliper-side control portion 41 is connected to the power supply line 29 in the main control portion 21. Although omitted from FIG. 2, the motor control device 20 includes another caliper-side control portion that is similar to the caliper-side control portion 41. The power supply line 25 that outputs source voltage to the caliper-side control portion is connected to the power supply line 29 in the main control portion 21.

For example, if the electric brake device 1 includes the brake mechanism 10 for a right rear wheel and the brake mechanism 10 for a left rear wheel, the caliper-side control portion 41 shown in FIG. 2 functions as a control portion for the brake mechanism 10 for either the right or left rear wheel which includes the electric motor 11, whereas another caliper-side control portion mentioned above functions as a control portion for the brake mechanism 10 for the other rear wheel. If the electric brake device 1 includes more brake mechanisms, the motor control device 20 may include caliper-side control portions similar to the caliper-side control portion 41 which are provided to the respective brake mechanisms 10. The caliper-side control portions are connected to the main control portion 21 through respective output-side switching circuits.

The invention is not limited to specific configurations of the first and second input-side switching circuits 22 and 23. It is nonetheless preferable that the switching circuits 22 and 23 comprise semiconductor switch elements (MOS-FETs, for example). For example, if the switching circuits 22 and 23 comprise MOS-FETs, the control signals 32 and 33 have equivalent function to gate drive voltage for controlling the ON/OFF of the respective MOS-FETs.

The controller 26 and the controller 36 are preferably configured as publicly-known microcomputer systems that each include a CPU (Central Processing Unit), a ROM (Read Only Memory), a RAM (Random Access Memory), an I/O (Input/Output) interface, and the like. The controller 26 and/or the controller 36 may instead partially or entirely comprise freely-selected proper hardware, software or a combination of the hardware and the software as long as the controller 26 and/or the controller 36 is capable of implementing the drive control of the motor which will be discussed later.

In the electric brake device 1, the electric motor 11 comprises, for example, a three-phase synchronous motor. Accordingly, the motor driving portion 42 of the caliper-side control portion 41 comprises a three-phase inverter device that converts DC power supplied through the power supply line 30 into three-phase AC power and outputs the three-phase AC power to the electric motor 11. The controller 36 outputs to the motor driving portion 42 a switch control signal 37 for controlling the ON/OFF of the semiconductor switch elements, not shown, which form the three-phase inverter device. The motor driving portion 42 drives the electric motor 11 in accordance with the switch control signal 37. The controller 26 of the main control portion 21 corresponds to a command signal corresponding to a target value of operating parameter of the electric motor 11, such as the rotating speed of the electric motor 11. The controller 36 controls the motor driving portion 42 in accordance with the command signal 31.

The motor driving portion 42 may be directly switch-controlled by the controller 26 of the main control portion 21.

The operation of the electric brake device 1 thus configured will be discussed below on the premise that the voltage of the first electricity storage device 27 ranges from 12 V to 14 V, and that the voltage of the second electricity storage device 28 is stored so as to range from 24 V to 30 V.

During normal operation of the electric brake device 1, the controller 26 uses the control signals 32 and 33 to turn on the first input-side switching circuit 22 and turn off the second input-side switching circuit 23. The power supply line 29 is supplied with the voltage of the first electricity storage device 27. In such a state, the voltage of the first electricity storage device 27 is outputted from the control portion 21 through the power supply line 30 to the motor driving portion 42 of the caliper-side control portion 41, for example, in accordance with a brake pedal operation by a vehicle driver. At the same time, the controller 26 of the main control portion 21 outputs the command signal 31 corresponding to predetermined rotating speed to the controller 36 of the caliper-side control portion 41. The controller 36 then activates the motor driving portion 42 in accordance with the command signal 31, which makes the electric motor 11 rotate at the predetermined rotating speed. The rotation of the electric motor 11 that is driven by receiving power supply from the first electricity storage device 27 is converted into linear motion by the rotation-linear motion conversion mechanism 12 of the brake mechanism 10. The linear motion transmits thrust to the piston 4, and then, the brake pads 2 and 3 moved by the piston 4 press the disc D, to thereby generate a braking force.

In the electric brake device 1, the second electricity storage device 28 first functions as a backup power source provided to prepare for a situation where the first electricity storage device 27 fails or has some other failure, and therefore, the first electricity storage device 27 is decreased in source voltage. To be specific, the controller 26 uses the control signals 32 and 33 to turn off the first input-side switching circuit 22 and turn on the second input-side switching circuit 23 when the first electricity storage device 27 has a voltage equal to or lower than a predetermined value (10 V, for example). The power supply line 29 is thus supplied with the voltage of the second electricity storage device 28. In such a state, the voltage of the second electricity storage device 28 is outputted from the main control portion 21 through the power supply line 30 to the motor driving portion 42 of the caliper-side control portion 41, for example, in accordance with the brake pedal operation by the driver. At the same time, the controller 26 of the main control portion 21 outputs the command signal 31 corresponding to the predetermined rotating speed to the controller 36 of the caliper-side control portion 41. The controller 36 then activates the motor driving portion 42 in accordance with the voltage of the second electricity storage device 28 and the command signal 31, which makes the electric motor 11 rotate at the predetermined rotating speed. The rotation of the electric motor 11 that is driven by receiving power supply from the second electricity storage device 28 generates a braking force by the above-described operation of the brake mechanism 10.

The electric brake device 1 further supplies electric power from the second electricity storage device 28 to the electric motor 11 when the electric motor 11 is required to be driven at higher rotating speed than the predetermined rotating speed. In other words, the controller 26 uses the control signals 32 and 33 to turn off the first input-side switching circuit 22 and turn on the second input-side switching circuit 23 when the electric motor 11 is required to be driven at higher rotating speed than the predetermined rotating speed. The power supply line 29 is then supplied with the voltage of the second electricity storage device 28. In such a state, the voltage of the second electricity storage device 28 is outputted from the main control portion 21 through the power supply line 30 to the motor driving portion 42 of the caliper-side control portion 41. At the same time, the controller 26 of the main control portion 21 outputs the command signal 31 corresponding to the required rotating speed that is higher than the predetermined rotating speed to the controller 36 dedicated for the caliper-side control portion 41. The controller 36 activates the motor driving portion 42 in accordance with the voltage of the second electricity storage device 28 and the command signal 31, which makes the electric motor 11 rotate at the required rotating speed that is higher than the predetermined rotating speed. The rotation of the electric motor 11 that is driven by receiving power supply from the second electricity storage device 28 generates a braking force by the above-described operation of the brake mechanism 10.

Situations where the electric motor 11 is required to be driven at higher rotating speed than the predetermined rotating speed include when emergency brake is applied. The emergency brake may be an automatic emergency brake (AEB) that automatically implements brake control when an obstacle is detected, for example, using a radar, a camera, an infrared radar or the like, and the vehicle approaches the obstacle. The urgency of the emergency brake may be judged on the basis of amount of the brake pedal operation by the vehicle driver and/or a pedaling rate. If the electric motor 11 is required to be driven at higher rotating speed than the predetermined rotating speed, the emergency brake may be applied when the piston 4 is propelled toward the disc D from a farthest position from the disc D as seen in a situation where the electric brake device 1 starts up after the piston 4 is retracted from the brake pad 2, for example, in order to replace the brake pads 2 and 3 or for another reason.

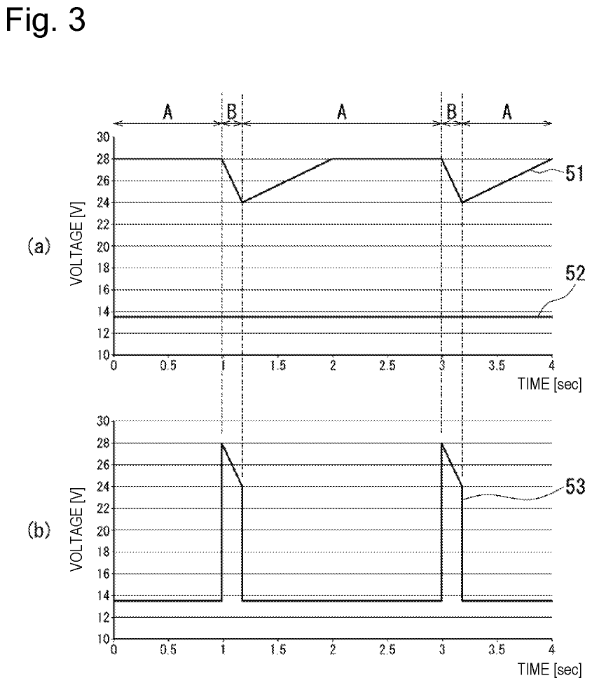

FIG. 3 shows an example of timing of switching between the first electricity storage device 27 and the second electricity storage device 28. FIG. 3 (a) is a graph showing temporal changes in voltage 52 of the first electricity storage device 27 and voltage 51 of the second electricity storage device 28. FIG. 3 (b) is a graph showing a temporal change in source voltage (namely motor driving voltage) that is outputted from the main control portion 21 through the power supply line 30 to the motor driving portion 42 of the caliper-side control portion 41. An interval denoted by A in FIGS. 3 (a) and 3 (b) is a time period when the electric brake device 1 is in normal operation or when the electric brake device 1 is not in operation. An interval denoted by B is a time period when the emergency brake is applied.

The voltage 52 of the first electricity storage device 27 is constant (approximately 13.5 V in the example of FIG. 3) over an entire period. In an initial interval A (from 0 seconds to 1 second), the first input-side switching circuit 22 is ON, and the second input-side switching circuit 23 is OFF. As shown in FIG. 3 (b), motor driving voltage 53 is the voltage 52 of the first electricity storage device 27. In the interval A, as shown in FIG. 3 (a), the voltage 51 of the second electricity storage device 28 is constant (28 V in the example in FIG. 3), too.

In an interval B (from approximately 1 second to 1.2 seconds) subsequent to the interval A, the first input-side switching circuit 22 is OFF, and the second input-side switching circuit 23 is ON. Accordingly, the power source that supplies electric power to the electric motor 11 is switched to the second electricity storage device 28. As shown in FIG. 3 (b), the motor driving voltage 53 is switched to the voltage 51 of the second electricity storage device 28. Since the second electricity storage device 28 comprises the electric double-layer capacitor (EDLC), the voltage 51 of the second electricity storage device 28 (namely the motor driving voltage 53) is decreased due to electric discharge as the interval B lasts as shown in FIG. 3 (a). In the example shown in FIG. 3, the voltage 51 of the second electricity storage device 28 reaches 24 V at the end of the interval B.

In the subsequent interval A (from approximately 1.2 to 3 seconds), the first input-side switching circuit 22 is ON, and the second input-side switching circuit 23 is OFF again. The power source that supplies electric power to the electric motor 11 is switched to the first electricity storage device 27. As shown in FIG. 3 (b), therefore, the motor driving voltage 53 is switched to the voltage 52 of the first electricity storage device 27. When the interval A begins, the second electricity storage device 28 starts being charged. The voltage of the second electricity storage device 28 is restored to initial voltage (28 V in the example shown in FIG. 3) at a time point after a lapse of a predetermined time period (approximately 2 seconds in the example shown in FIG. 3).

Afterwards, the power source is switched back and forth between the first electricity storage device 27 and the second electricity storage device 28 depending on whether the interval is A or B.

In conventional brake devices, an electric motor is driven at a constant source voltage of, for example, 12 V. In order to increase the rotating speed of the electric motor to improve the responsiveness of a brake device or realize the high responsiveness thereof, it has been necessary to increase source current of a power source that drives the motor. The increase of the current leads to increase of copper loss. In order to reduce the copper loss, it has been necessary to enlarge the size of the electric motor and/or an inverter device for driving the electric motor. Consequently, parts cost is increased.

In contrast with the conventional brake devices, in the brake device (electric brake device 1) and the motor control device (motor control device 20) according to the invention, there are provided the electric motor 11 that is driven by receiving power supply from the first electricity storage device 27, and the second electricity storage device 28 that is capable of storing higher voltage than the first electricity storage device 27. The second electricity storage device 28 supplies electric power to the electric motor 11 when the electric motor 11 is required to be driven at higher rotating speed than the predetermined rotating speed. This enables the electric motor 11 to be driven at high rotating speed while preventing or suppressing the increase of the source current and without causing voltage saturation attributable to inductive voltage of the electric motor 11. This makes it possible to improve the responsiveness of the electric brake device 1 as needed.

Such a high responsiveness of the brake device (electric brake device 1) of the invention is particularly desirable for reliable crash avoidance when the emergency brake is applied.

In the brake device (electric brake device 1) and the motor control device (motor control device 20) according to the invention, the second electricity storage device 28 supplies electric power to the electric motor 11 when the first electricity storage device 27 has a voltage equal to or lower than the predetermined value. In other words, an electricity storage device which functions as a backup power source provided to prepare for failure of the first electricity storage device 27 is used in a conventional brake device as the second electricity storage device 28 of the invention while maintaining equivalent functions to conventional art. From this aspect, too, the invention improves the responsiveness of the electric brake device 1 without requiring higher parts cost as compared to conventional brake devices. Conventional backup power sources are provided basically to prepare for failure of the first electricity storage device 27 which occurs only rarely. Again, the invention is desirable from the aspect of effective utilization of parts.

In the electric brake device 1 and the motor control device 20 according to the first embodiment, since the second electricity storage device 28 comprises the electric double-layer capacitor (EDLC), charge and discharge of the second electricity storage device 28 do not cause a chemical reaction. This makes the second electricity storage device 28 excellent in durability.

In the electric brake device 1 and the motor control device 20 according to the first embodiment, the motor control device 20 drives the electric motor 11 through a closed circuit that is separated from external factors. Therefore, if charge voltage of the second electricity storage device 28 ranges from approximately 24 V to 30 V relative to the voltage of the first electricity storage device 27 which is approximately 12 V as with conventional art, the motor driving portion 42 may be any kind as long as the motor driving portion 42 has voltage resistance (up to 40 V, for example) that is equivalent to a motor driving portion (more specifically, an inverter device) of a conventional brake device. From this aspect, too, the electric brake device 1 and the motor control device 20 according to the first embodiment improve the responsiveness of the electric brake device 1 without requiring higher parts cost as compared to conventional brake devices and motor control devices.

In the electric brake device 1 and the motor control device 20 according to the first embodiment, the first and second input-side switching circuits 22 and 23 are included in a conventional motor control device provided with an electricity storage device that functions only as a backup power source. Just like the motor driving portion 42 discussed above, the switching circuits 22 and 23 (preferably semiconductor switch elements) may be any kind as long as the switching circuits 22 and 23 have voltage resistances equivalent to voltage resistances of respective parts used in conventional motor control devices. The motor control device 20 according to the first embodiment can be materialized simply by altering control sequences of the first and second input-side switching circuits 22 and 23 which are carried out by the controller 26 without altering hardware configuration in conventional motor control devices and therefore without increasing parts cost.

According to the first embodiment, the high responsiveness of the electric brake device 1 is particularly desirable for prompt generation of the braking force when the piston 4 is propelled toward the disc D from the farthest position from the disc D.

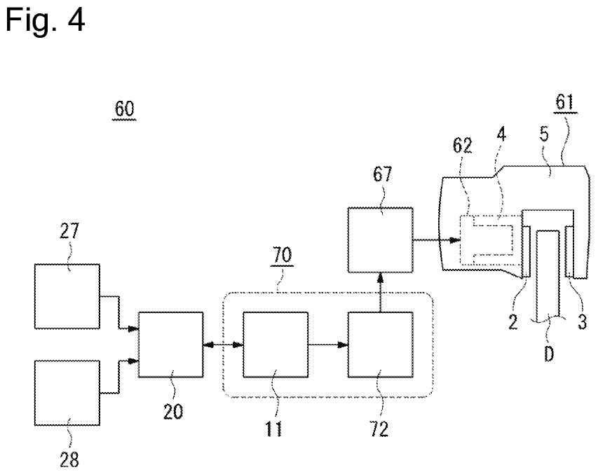

The following discussion explains a brake device 60 according to a second embodiment of the invention with a focus on differences from the first embodiment with reference to FIG. 4. Components and portions similar or corresponding to those of the first embodiment are referred to by the same terms and reference signs as in the first embodiment.

The brake device 60 is a hydraulic braking device that applies a braking force to each wheel by squeezing a disc D rotating with each wheel, not shown, of a vehicle. The brake device 60 includes a brake mechanism 61 including brake pads 2 and 3 pressed against the disc D and a piston 4 that is slidably disposed in an inner periphery of a cylinder 62 of a caliper 5 and moves the brake pads 2 and 3. The brake mechanism 61 is provided to each wheel to be braked by the brake device 60.

The brake device 60 includes a master cylinder 67 that generates hydraulic pressure supplied into the cylinder 62 of the caliper 5 and an electric booster device 70 that transmits to the master cylinder 67. The electric booster device 70 includes an electric motor 11 that drives a booster piston, not shown, capable of adjusting the hydraulic pressure in the master cylinder 67 and a rotation-linear motion conversion mechanism 72 that converts the rotation of the electric motor 11 into linear motion and transmits the linear motion to the booster piston. The electric booster device 70 is capable of implementing various brake controls, such as regenerative cooperative control, brake assist, and automatic brake, using the electric motor 11 that is driven-controlled by a motor control device 20 described later, in consort with depression of a brake pedal, not shown, or regardless of operation of the brake pedal.

The brake device 60 further includes the motor control device 20 that controls operation of the electric motor 11, and first and second electricity storage devices 27 and 28 that supply electric power to the electric motor 11 through the motor control device 20.

The brake device 60 is so configured that the hydraulic pressure is generated in the master cylinder 67 by the electric motor 11 that is driven under the drive control implemented by the motor control device 20 and therefore that a braking force is generated in the brake mechanism 61 of each wheel.

The electric motor 11 and the first and second electricity storage devices 27 and 28 in the brake device 60 are similar to the respective constituent elements of the electric brake device 1 of the first embodiment. The motor control device 20 in the brake device 60 functions similarly to the motor control device 20 of the electric brake 1 of the first embodiment in terms of the switching between the first electricity storage device 27 and the second electricity storage device 28 and the driving of the electric motor 11.

With the above-discussed configuration, the brake device 60 and the motor control device 20 provide similar operation and advantageous effects to those discussed above in relation to the electric brake device 1 and the motor control of the first embodiment.

The invention is not limited to the embodiments discussed above and may be modified in various ways. For example, the embodiments describe the invention in detail to facilitate the understanding of the invention and do not necessarily have to include all the configurations mentioned above. It is possible to partially replace the configuration of one of the embodiment with the configuration of the other embodiment and also incorporate the configuration of one of the embodiments into that of the other embodiment. The configuration of each of the embodiments may be partially combined or replaced with the configuration of the other embodiment and also may be deleted.

The present application claims priority under Japanese Patent Application No. 2018-060359 filed on Mar. 27, 2018. The entire disclosure of Japanese Patent Application No. 2018-060359 filed on Mar. 27, 2018 including the description, claims, drawings and abstract, is incorporated herein by reference in its entirety.

### REFERENCE SIGN LIST

1: Electric brake device (brake device)
2, 3: Brake pad
4: Piston
11: Electric motor
10, 61: Brake mechanism
20: Motor control device
27: First electricity storage device
28: Second electricity storage device
60: Brake device
D: Disc

1. A brake device comprising:
a brake mechanism configured to generate a braking force by an electric motor that is driven by receiving power supply from a first electricity storage device, and
a second electricity storage device configured to supply electric power to the electric motor in a situation where the first electricity storage device has a voltage equal to or lower than a predetermined value,
the second electricity storage device being capable of storing higher voltage than the first electricity storage device and configured to supply electric power to the electric motor when the electric motor is required to be driven at higher rotating speed than predetermined rotating speed.

2. The brake device according to claim 1,
wherein the situation where the electric motor is required to be driven at higher rotating speed than the predetermined rotating speed is when emergency brake is applied.

3. An electric brake device comprising:
a brake mechanism configured to transmit thrust to a piston that moves brake pads pressed against a disc by an electric motor that is driven by receiving power supply from a first electricity storage device, and
a second electricity storage device configured to supply electric power to the electric motor when the first electricity storage device has a voltage equal to or lower than a predetermined value,
the second electricity storage device being capable of storing higher voltage than the first electricity storage device and configured to supply electric power to the electric motor in a situation where the electric motor is required to be driven at higher rotating speed than predetermined rotating speed.

4. The electric brake device according to claim 3,
wherein the situation where the electric motor is required to be driven at higher rotating speed than the predetermined rotating speed is when emergency brake is applied.

5. The electric brake device according to claim 3,
wherein the situation where the electric motor is required to be driven at higher rotating speed than the predetermined rotating speed is when the piston is propelled toward the disc from a farthest position from the disc.

6. A motor control device that switches between a first electricity storage device and a second electricity storage device capable of storing higher voltage than the first electricity storage device to supply electric power to an electric motor,
the motor control device being configured to supply electric power from the second electricity storage device to the electric motor in a situation where the electric motor is driven at higher rotating speed than predetermined rotating speed.
